(19) United States
(12) Patent Application Publication
(10) Pub. No.: US 2012/0086698 A1
(43) Pub. Date: Apr. 12, 2012

(54) SWITCH APPARATUS

(75) Inventor: Akihiro SUZUKI, Kariya-city (JP)

(73) Assignee: DENSO CORPORATION, Kariya-city (JP)

(21) Appl. No.: 13/252,281

(22) Filed: Oct. 4, 2011

(30) Foreign Application Priority Data
Oct. 6, 2010 (JP) 2010-226879

(51) Int. Cl. G06F 3/038

(52) U.S. Cl. 345/212

(57) ABSTRACT

A switch apparatus includes multiple operation switches and a display controller. Each of the operation switches has a display unit constructed of electronic paper that can rewrite a display image in a condition of being supplied with electric power and retain a rewritten display image after electric power supply is terminated. The display controller performs a display image rewriting processing that permits electric power supply to a target display unit, instructs the target display unit to rewrite a display image, and terminates electric power supply to the target display unit after instructing the target display unit to rewrite the display image. The display controller performs the display image rewriting processing successively to any of the display units whose display image is to be rewritten.

### CROSS REFERENCE TO RELATED APPLICATION

This application is based on Japanese Patent Application No. 2010-226879 filed on Oct. 6, 2010, the disclosure of which is incorporated herein by reference.

### FIELD OF THE INVENTION

The present invention relates to a switch apparatus having multiple operation switches.

### BACKGROUND OF THE INVENTION

A switch device having a displaying function in an operation switch has been proposed, for example, in US2008/0259227A1.

In a switch device as described in US2008/0259227A1, it is necessary to always supply electric power to display a display image during in operation. Therefore, consumed power is likely to increase. Further, in a case where multiple operation switches are arranged, a display control circuit for controlling a display image needs to be employed to each of the operation switches. Therefore, the number of components is likely to increase.

### SUMMARY OF THE INVENTION

The present invention is made in view of the forgoing matter, and it is an object to provide a switch apparatus capable of reducing the number of components and power consumption.

According to an aspect, a switch apparatus includes multiple operation switches and a display controller. Each of the operation switches has a display unit including electronic paper that rewrites a display image in a condition of being supplied with electric power and retains a rewritten display image after electric power supply is terminated. The display controller performs a display image rewriting processing that permits electric power supply to a target display unit, which is any one of the display unit whose display image is to be rewritten, instructs the target display unit to rewrite the display image, and terminates electric power supply to the target display unit after instructing the target display to rewrite the display image. The display controller performs the display image rewriting processing successively for any of the display units whose display image is to be rewritten.

In such a configuration, the display image rewriting processing is successively performed to the display units by the single display controller. Therefore, the number of components can be reduced, and power consumption can be reduced.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a front view of a switch apparatus according to a first embodiment;

FIG. 2 is a block diagram of the switch apparatus according to the first embodiment;

FIGS. 3A through 3D are schematic views for illustrating data frames of the switching apparatus according to the first embodiment;

FIG. 4 is a flow chart of a display image rewriting processing performed by a common controller of the switch apparatus according to the first embodiment;

FIG. 5 is a block diagram of a switch apparatus according to a second embodiment;

FIG. 6 is a block diagram of a switch apparatus according to a third embodiment;

FIG. 7 is a block diagram of a switch apparatus according to a fourth embodiment;

FIG. 8 is a front view of a display unit of a switch apparatus according to a fifth embodiment; and

FIG. 9 is a schematic block diagram of a switch apparatus according to a sixth embodiment.

### DETAILED DESCRIPTION OF EXEMPLARY EMBODIMENTS

### First Embodiment

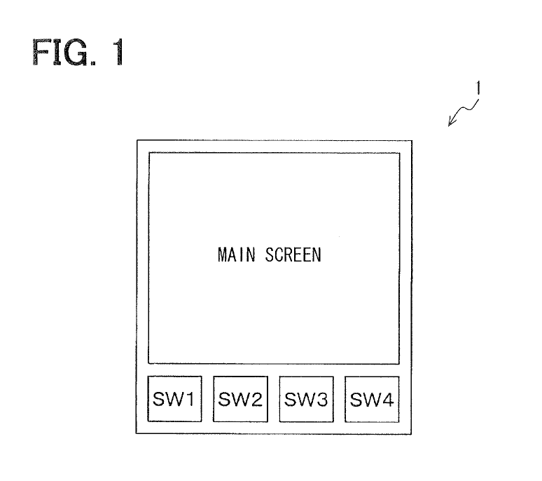

Referring to FIG. 1, a switch apparatus 1 according to a first embodiment has multiple operation switches SW1, SW2, SW3, and SW4 under a main screen. Each of the operation switches SW1-SW4 is provided as a switch that outputs a signal in response to a user's operation.

Each of the operation switches SW1-SW4 is provided with a display unit that is constructed of electronic paper that can rewrite a display image in a power-supplied condition and retain a rewritten display image even after the electric power supply is terminated. A detailed structure of the display unit will be described later.

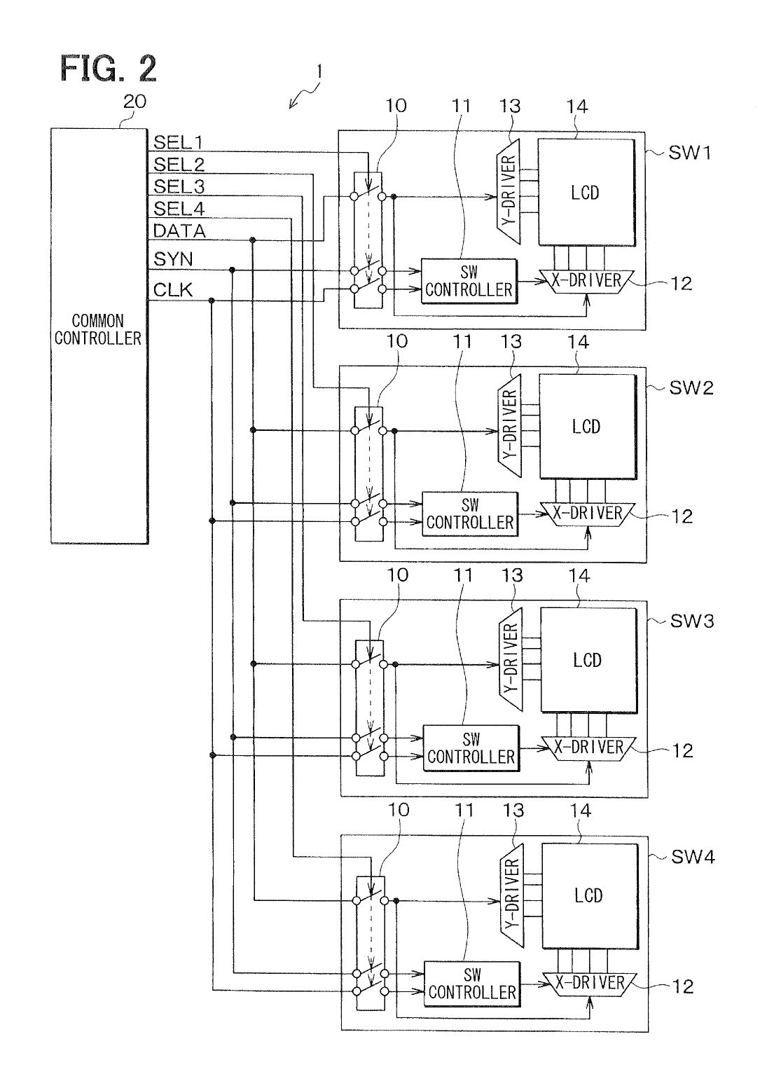

Referring to FIG. 2, the switch apparatus 1 generally includes the operation switches SW1-SW4 and a common controller 20 as a display controller or a display control circuit.

Each of the operation switches SW1-SW4 includes a switch circuit 10, a switch controller 11, an X-driver 12, a Y-driver 13 and a liquid crystal display portion 14. The switch controller 11, the X-driver 12, the Y-driver 13 and the liquid crystal display portion 14 constitute the display unit provided by the electronic paper.

The switch circuit 10 switches connection and disconnection between the common controller 20 and the corresponding operation switch SW1-SW4 in accordance with a selection signal generated from the common controller 20. The switch circuit 10 is for example constructed of a semiconductor switch, such as a switching transistor, a relay or the like. Although not illustrated in FIG. 2, the switch circuit 10 turns on and off the electric power supply to the switch controller 11, the X-driver 12 and the Y-driver 13.

The switch controller 11 generates a clock signal and the like for distributing display image data over pixels of the display area of the liquid crystal display portion 14, and supplies such signals to the X-driver 12 and the Y-driver 13.

The X-driver 12 and the Y-driver 13 rewrite a display image displayed in the display area of the liquid crystal display portion 14 by applying a voltage to each pixel of the liquid crystal display portion 14 in accordance with the signal from the switch controller 11.

The liquid crystal display portion 14 is provided by sheet-like electronic paper that uses a liquid crystal material, such as cholesteric liquid crystal. The cholesteric liquid crystal has a feature that reflects only the light having a specific wave length. The cholesteric liquid crystal carries out full color display by reflecting lights of the predetermined wave lengths, such as red, green and blue, when receiving sunlight or fluorescent light.

The electronic paper using such a liquid crystal material has many characteristics. For example, the electronic paper can keep displaying the display image even after the electric power supply is terminated, and electric power required to rewrite the display image is small. Also, the electronic paper is thin, light, and flexible.

The liquid crystal display portion 14 is fixed to an operation surface of each operation switch SW1-SW4.

The common controller 20 is provided by a computer including a CPU, a memory and the like. The CPU executes various processing in accordance with programs stored in the memory.

The common controller 20 sends various data for instructing rewriting of the display image to the operation witch SW1-SW4. The various data for instructing the rewriting of the display image include a clock signal CLK, a synchronization signal SYN, a data signal DATA, and selection signals SEL1 through SEL4, for example.

The common controller 20 selects one of a full-display rewriting mode to fully rewrite the display area, a one-pixel rewriting mode to rewrite one pixel of the display area, a multiple-pixel rewriting mode to rewrite multiple pixels of the display area, and a one-line rewriting mode to rewrite one line of the display area, and instructs the operation switch SW1-SW4 to rewrite the display image in the selected mode.

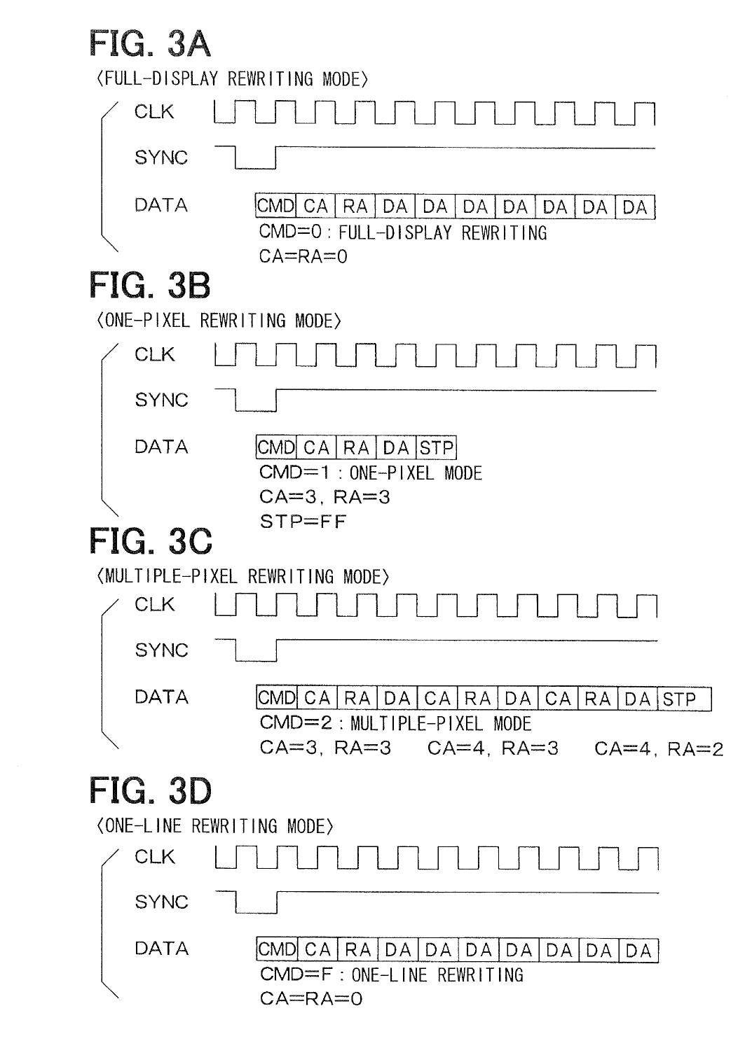

FIG. 3A shows a data frame of the full-display rewriting mode. FIG. 3B shows a data frame of the one-pixel rewriting mode. FIG. 3C shows a data frame of the multiple-pixel rewriting mode. FIG. 3D shows a data frame of the one-line rewriting mode. In each of the data frames, CMD represents a mode command, CA represents a column address, RA represents a row address, and DA represents color data.

In the full-display rewriting mode, the mode command CMD is indicated as 0h (h represents hexadecimal number). In the one-pixel rewriting mode, the mode command CMD is indicated as 1h. In the multiple-pixel rewriting mode, the mode command CMD is indicated as 2h. In the one-line rewriting mode, the mode command CMD is indicated as Fh.

For example, in the full-display rewriting mode to rewrite the whole of the display image of the display area, a data rewriting command in which CMD=0h, CA=RA=0, and the DA indicates data for specifying color is generated.

In the one-pixel rewriting mode to rewrite one pixel of the display image, a data rewriting command where CMD=1h, the CA and the RA indicate the position of the pixel to be rewritten, and the DA indicates data for specifying color is generated.

In the multiple-pixel rewriting mode to rewrite multiple pixels of the display image, a data rewriting command in which the CMD is set to 2h, and then position data for specifying the positions of the pixels to be rewritten and data for specifying the color data are alternately indicated is generated.

In the one-line rewriting mode to rewrite one line of the display image, a data rewriting command in which the CMD is set to Fh, and then position data specifying the position of the line to be rewritten and data for specifying the color data are indicated is generated.

As described above, the common controller 20 selects one mode, and instructs the operation switch SW1-SW4 to rewrite the display image in accordance with the selected mode.

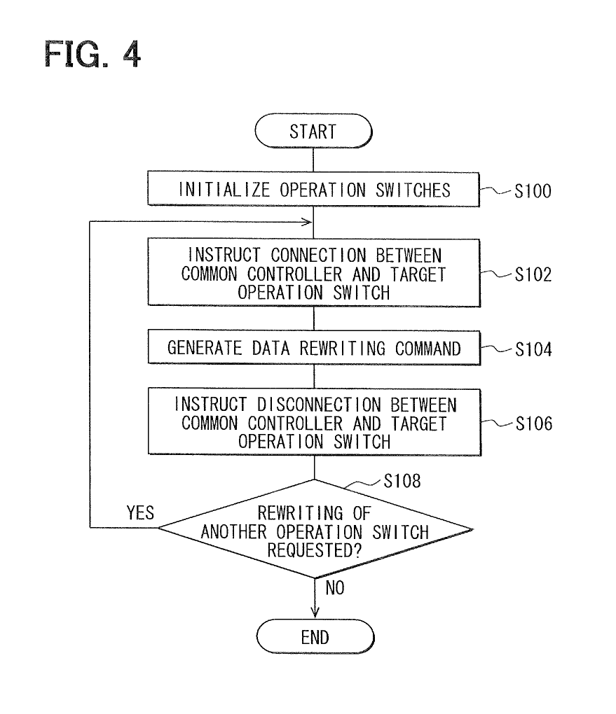

Next, a display image rewriting processing performed by the common controller 20 will be described with reference to FIG. 4. When externally receiving a request to rewrite the display image, the common controller 20 initiates the processing shown in FIG. 4.

At S100, the liquid crystal display portion 14 of each operation switch SW1-SW4 is initialized. For example, the common controller 20 instructs the switch circuits 10 of all the operation switches SW1-SW4 to connect all the liquid crystal display portions 14 with the common controller 20. Also, the common controller 20 reads out initializing data, which is prepared beforehand, from the memory, and instructs the liquid crystal display portions 14 of all the operation switches SW1-SW4 to display initial data. In the present embodiment, for example, the liquid crystal display portions 14 are fully displayed in a predetermined color, e.g., black, by the display of the initial data.

At S102, the common controller 20 specifies the operation switch to be rewritten (hereinafter, referred to as the target operation switch). Also, the common controller 20 instructs the switch circuit 10 of the target operation switch to connect between the target operation switch and the common controller 20, and instructs the switch circuits 10 of the operation switches other than the target operation switch to disconnect the other operation switches from the common controller 20.

For example, in a case where the liquid crystal display portion 14 of the operation switch SW1 is specified to be rewritten, that is, the operation switch SW1 is specified as the target operation switch, the switch circuit 10 of the operation switch SW1 is instructed to be in an on state, and the switch circuits 10 of the operation switches SW2 through SW4 are instructed to be in an off state. When the switch circuit 10 of the operation switch SW1 is in the on state, the controller 11, the X-driver 12 and the Y-driver 13 of the operation switch SW1 are supplied with electric power. On the other hand, because the switch circuits 10 of the operation switches SW2 through SW4 are in the off state, the controllers 11, the X-drivers 12 and the Y-drivers 13 of the operation switches SW2 through SW4 are not supplied with electric power.

At S104, the common controller 20 generates a data rewriting command. For example, in a case where the full display area of the liquid crystal display portion 14 of the operation switch SW1 is to be rewritten, the data rewriting command indicating CMD=0h, CA=RA=0, DA specifying color data is generated. Thus, the full display area of the liquid crystal display portion 14 of the operation switch SW1 is rewritten.

At S106, the common controller 20 instructs the switch circuit 10 of the target operation switch to terminate the connection between the target operation switch and the common controller 20. For example, the common controller 20 instructs the switch circuit 10 of the operation switch SW1 to be in the off state.

When the switch circuit 10 of the operation switch SW1 is in the off state, the electric power supply to the switch controller 11, the X-driver 12, and the Y-driver 13 of the operation switch SW1 is terminated. In this case, the liquid crystal display portion 14 has a characteristic of retaining the display image even after the electric power supply is terminated. Therefore, the display image of the liquid crystal display portion 14 of the operation switch SW1 remains.

At S108, the common controller 20 determines whether or not there is a display image rewriting request to rewrite a display image of another liquid crystal display portion 14. For example, in a case where there is the display image rewriting request to rewrite the display image of the liquid crystal display portion 14 of the operation switch SW2, the common controller 20 specifies the operation switch SW2 as the target operation switch, and performs the processing from S102 to S106 for the liquid crystal display portion 14 of the operation switch SW2.

In this way, the common controller 20 repeats the processing from S102 to S106 until it is determined that there is no request to rewrite the display image of any other liquid crystal display portions 14.

When determining at S108 that there is no request to rewrite the display image of the liquid crystal display portion 14 in any of the operation switches SW1-SW4, the common controller 20 ends the display image rewriting processing.

In this way, the common controller 20 permits the electric power supply to the target display unit, instructs the target display unit to rewrite the display image, and terminates the electric-power supply to the target display unit after instructing the target display unit to rewrite the display image. The common controller 20 performs this processing successively for the display units whose display image needs to be rewritten.

The above processing is performed successively for the display units whose display image needs to be rewritten by the single common controller 20. Therefore, the number of component parts can be reduced. Also, power consumption is reduced.

In the present embodiment, the switch controller 11, the X-driver 12, the Y-driver 13 and the liquid crystal display portion 14 constitute the display unit. The electric power supply to the target display unit is switched by the switch circuit 10 as a switching element. Also, the electric connection between the controller 20 and the target display unit is switched by the switch circuit 10. The common controller 20 instructs the switch circuit 10 to connect the target display unit with the common controller 20 and to turn on the electric power supply to the target display unit. In this condition, the controller 20 generates the instruction to rewrite the display image of the target display unit. After generating the instruction to rewrite the display image of the target display unit, the common controller 20 instructs the switch circuit 10 to terminate the electric power supply to the target display unit.

### Second Embodiment

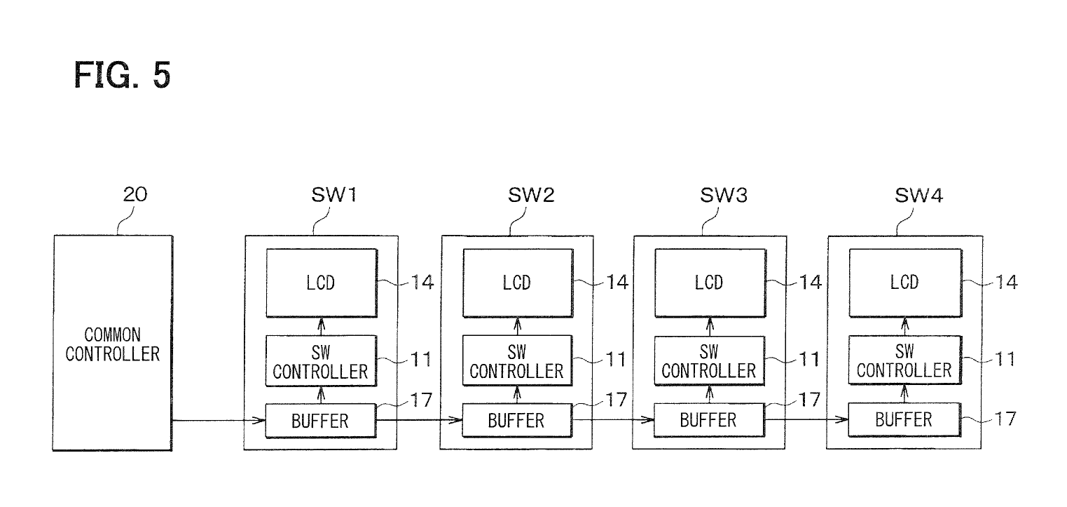

FIG. 5 is a schematic diagram of a switch apparatus 1 according to a second embodiment. In the switch apparatus 1 according to the present embodiment, the liquid crystal display portions 14 of the multiple switches SW1-SW4 are connected multistage relative to the common controller 20.

Hereinafter, components similar to those of the first embodiments are denoted with like reference numbers, and a description thereof will not be repeated. A structure different from the first embodiment will be mainly described.

Referring to FIG. 5, each of the operation switches SW1-SW4 includes a buffer 17, the switch controller 11 and the liquid crystal display portion 14. Although the X-driver 12 and the Y-driver 13 are not illustrated in FIG. 5 for the purpose of clarity, the display unit of each of the operation switches SW1-SW4 actually includes the X-driver 12 and the Y-driver 13. Also, although not illustrated in FIG. 5, a receiver circuit for detecting the receipt of a packet is disposed on a signal inputting portion of each buffer 17.

The common controller 20 has a packet generating element to generate a packet. The common controller 20 instructs the target display unit to rewrite the display image of the liquid crystal display portion 14 by transmitting the packet to the target display unit.

When the receiver circuit of the target operation switch receives the packet addressed thereto, the switch circuit provided in the target operation switch is turned on. Thus, the electric power is supplied to the buffer 17, the controller 11, the X-driver 12, the Y-driver 13 and the liquid crystal display portion 14 of the target operation switch through the switch circuit.

The packet includes the instruction to rewrite the display image. After the display image on the display area of the liquid crystal display portion 14 of the target operation switch is rewritten by the controller 11 in accordance with the instruction indicated in the packet, the switch circuit is turned off. As such, the electric power supply to the controller 11, the X-driver 12, the Y-driver 13 and the liquid crystal display portion 14 is terminated.

In this way, the common controller 20 permits the electric power supply to the target display unit, instructs the target display unit to rewrite the display image, and terminates the electric power supply to the target display unit after instructing the target display unit to rewrite the display image. The common controller 20 performs this processing successively for the display units whose display image needs to be rewritten. Further, the display units are connected multistage relative to the common controller 20. The instruction for permitting the electric power supply to the target display unit, instructing the target display unit to rewrite the display image, and terminating the electric power supply to the display unit is made through the package communication.

Accordingly, the multiple display units can be connected in the multistage manner. The common controller 20 can instruct at least one display unit to rewrite the display image through the packet communication. Also in the second embodiment, the advantageous effects similar to those of the first embodiment can be achieved.

### Third Embodiment

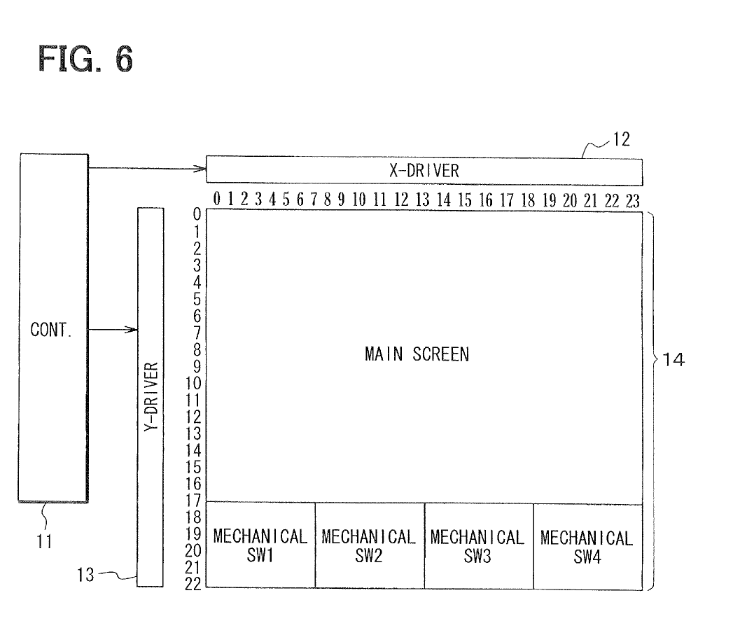

FIG. 6 is a schematic diagram of a switch apparatus 1 according to a third embodiment. In the switch apparatus 1 of the first embodiment, the liquid crystal display portion 14 is provided in each of the operation switches SW1-SW4. In the switch apparatus 1 of the present embodiment, on the other hand, the liquid crystal display portions 14 of the operation switches SW1-SW4 are provided by single electronic paper. The single electronic paper is disposed to cover front surfaces of the operation switches SW1-SW4 and a front surface of the main screen, as shown in FIG. 6. In other words, the operation switches SW1-SW4 and the main screen share the single liquid crystal display portion 14. In the present embodiment, therefore, a display image can be shown not only on the front surfaces of the operation switches SW1-SW4 but also on the front surface of the main screen by the electronic paper.

The common controller 20 divides the liquid crystal display portion 14 into multiple display areas corresponding to the front surface of the main screen and the front surfaces of the operation switches SW1-SW4, and performs the display image rewriting processing for each of the display areas.

In this configuration, since the display units are provided by single electronic paper, the number of components can be further reduced and workability during assembling can be improved.

### Fourth Embodiment

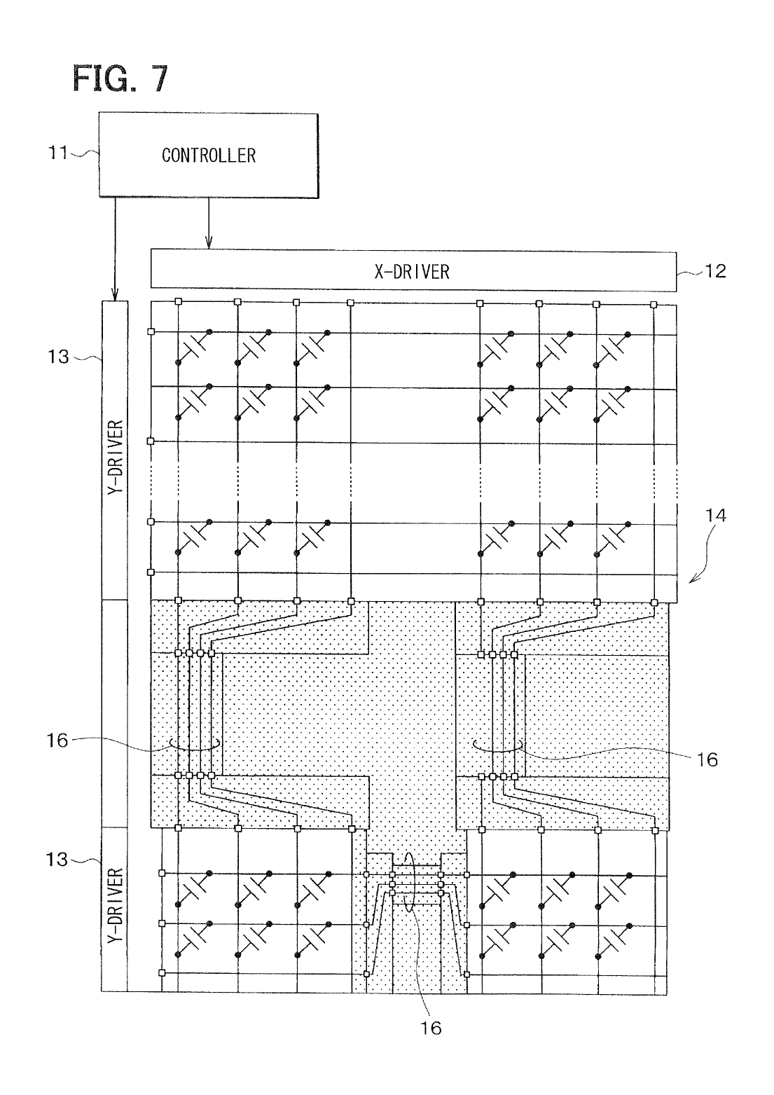

FIG. 7 is a schematic diagram of a switch apparatus 1 according to a fourth embodiment. In the switch apparatus 1 of the present embodiment, the liquid crystal display portions 14 are provided by the single electronic paper, similar to the third embodiment. The single electronic paper is disposed to cover the front surface of the main screen and the front surfaces of the operation switches SW1, SW2. In other words, the operation switches SW1, SW2 and the main screen share the one liquid crystal display portion 14.

In the switch apparatus 1 of the present embodiment, the main screen, the operation switch SW1 and the operation switch SW2 are arranged separately from each other. That is, in the liquid crystal display portion 14, an area corresponding to the spaces between the operation switches SW1, SW2 is a non-displaying area where a display image is not shown, as shown by a hatched area in FIG. 7. The liquid crystal material is not disposed in the non-displaying area. Further, wires 16 are provided in the non-displaying area to connect between the separated display areas.

In this way, the main screen and the multiple operation switches SW1, SW2 can be arranged separately from each other, and the wires 16 can be formed in the non-displaying area to connect between the separated display areas.

### Fifth Embodiment

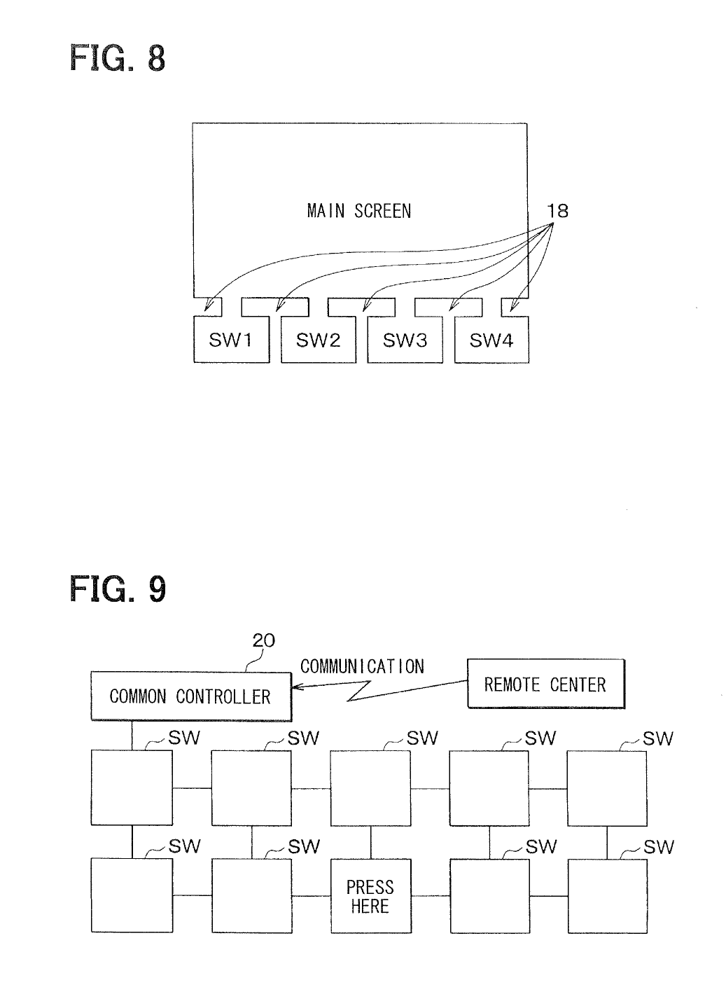

FIG. 8 is a plan view of a liquid crystal display portion 14 of a switch apparatus 1 according to a fifth embodiment. In the switch apparatus 1 of the present embodiment, the liquid crystal display portions 14 of the operation switches SW1-SW4 are provided by the single electronic paper, similar to the third embodiment. The single electronic paper is disposed to cover the front surface of the main screen and the front surfaces of the operation switches SW1-SW4. In other words, the operation switch SW1-SW4 and the main screen share the one liquid crystal display portion 14.

Further, the main screen, the operation switches SW1-SW4 are arranged separately from each other.

The liquid crystal display portion 14 has cutout portions 18 in the non-displaying area disposed between the separately arranged display areas to ease deformation of the display areas. For example, the operation switches SW1-SW4 are provided as movable pressing button switches. Even if the operation switches SW1-SW4 are displaced when being operated and stress due to the pressing operation is applied to the display areas, the stress can be alleviated by means of the cutout portions 18. Therefore, reliability of the liquid crystal display portion 14 improves.

The non-displaying portion is provided in areas corresponding to spaces between the main screen and the operation switches SW1-SW4. The liquid crystal material is not included in the non-displaying portion. Further, the wires are formed in the non-displaying area to connect between the separated display areas, similar to the wires 16 shown in FIG. 7. In this case, however, the wires are arranged away from the cutout portions 18.

### Sixth Embodiment

FIG. 9 is a schematic diagram of a switch apparatus 1 according to the sixth embodiment. The switch apparatus 1 of the present embodiment has ten operation switches SW. The common controller 20 is connected to each of the operation switches SW. Further, the common controller 20 can communicate with a remote center.

For example, if a user contacts an operator of the remote center to ask how to operate of an apparatus, such as a navigation apparatus, a wireless communication is performed between the remote center and the common controller 20. By a remote control of the operator of the remote center, letters or icon is displayed on the liquid display portion 14 of a target operation switch SW to be operated. In this way, operability of the switch apparatus 1 can be improved.

### Other Embodiments

In the first through sixth embodiments, the liquid crystal display portion 14 is provided by the electronic paper using the cholesteric liquid crystal. However, the liquid crystal display portion 14 may be provided by electronic paper using any other liquid crystal materials.

In the first through sixth embodiments, the electric power is supplied to the display unit in the above described manner. With regard to the sensing (control unit) of the operation switches, a conventional method or device may be employed. In such a case, electric power may be supplied to the operation switches separately from the electric power supplied to the display unit. Therefore, even if the electric power supply to the display unit is terminated, the operation switch can be still operated (controlled).

Additional advantages and modifications will readily occur to those skilled in the art. The invention in its broader term is therefore not limited to the specific details, representative apparatus, and illustrative examples shown and described.

What is claimed is:

1. A switch apparatus comprising:
a plurality of operation switches, each of the operation switches having a display unit, the display unit including electronic paper that rewrites a display image in a condition of being supplied with electric power and retains a rewritten display image after electronic power supply is terminated; and
a display controller that performs a display image rewriting processing that permits electric power supply to a target display unit, which is any one of the display units whose display image is to be rewritten, instructs the target display unit to rewrite the display image, and terminates the electric power supply to the target display unit after instructing the target display unit to rewrite the display image, wherein the display controller performs the display image rewriting processing successively to any of the display units whose display image is to be rewritten.

2. The switch apparatus according to claim 1, further comprising:
a switching element that turns on and off the electric power supply to the target display unit and connects and disconnects the target display unit to and from the display controller, wherein, in the display image rewriting processing, the display controller controls the switching element to turn on the electric power supply to the target display unit, to connect the target display unit to the display controller so that the target display unit receives an instruction to rewrite the display image from the display controller, and to turn off the electric power supply to the target display unit after the target display unit receives the instruction to rewrite the display image.

3. The switch apparatus according to claim 1, wherein
the display units are connected multistage relative to the display controller, and
the display controller instructs the target display unit to rewrite the display image through a communication line.

4. The switch apparatus according to claim 1, wherein
the display units of the operation switches are provided by single electronic paper disposed to cover front surfaces of the operation switches, the electronic paper defining display areas at locations corresponding to locations of the operation switches, and
the display controller performs the display image rewriting processing for rewriting the display image displayed in each display area.

5. The switch apparatus according to claim 4, wherein
the operation switches are spaced from each other,
the electronic paper has a non-displaying area where a display image is not displayed at a location corresponding to a space defined between the operation switches, and
the electronic paper has wires extended in the non-displaying area to connect between the display areas.

6. The switch apparatus according to claim 5, wherein the electronic paper has a cutout portion at the non-displaying area to allow deformation of the display areas.

7. The switch apparatus according to claim 6, wherein the wires are extended away from the cutout portion.
